(19) United States
(12) Patent Application Publication
(10) Pub. No.: US 2013/0077808 A1
(43) Pub. Date: Mar. 28, 2013

(54) ITE HEARING INSTRUMENT WITH PROGRAMMING CONNECTOR

(71) Applicant: SIEMENS MEDICAL INSTRUMENTS PTE. LTD., Singapore (SG)

(72) Inventors: SUBRAMANIAN BASHKARAN, SINGAPORE (SG); RUBAB SHAHBAZ KHAN, SINGAPORE (SG)

(73) Assignee: SIEMENS MEDICAL INSTRUMENTS PTE. LTD., SINGAPORE (SG)

(21) Appl. No.: 13/625,075

(22) Filed: Sep. 24, 2012

(30) Foreign Application Priority Data
Sep. 22, 2011 (DE) 10 2011 083 209.2

(51) Int. Cl. H04R 25/00

(52) U.S. Cl. 381/328

(57) ABSTRACT

An in-the-ear hearing instrument has a programming connector arranged in a faceplate and at least one microphone opening arranged in the faceplate. The programming connector is covered by an openable cover, and the at least one microphone opening is at least partially covered by at least one lining. The cover and at least one lining are integrated into a shared cover and lining device which at least partially covers both the programming connector and also the at least one microphone opening in a manner so as to be openable.

### CROSS-REFERENCE TO RELATED APPLICATION

This application claims the priority, under 35 U.S.C. §119, of German application DE 10 2011 083 209.2, filed Sep. 22, 2011; the prior application is herewith incorporated by reference in its entirety.

### BACKGROUND OF THE INVENTION

### Field of the Invention

The invention relates to a so-called ITE hearing instrument, which is equipped with a programming connector.

Hearing devices are known in various basic housing configurations. With in-the-ear (ITE) hearing devices, a housing, which contains all functional components including microphone and receiver, is largely worn in the auditory canal. Completely-in-canal (CIC) hearing devices are similar to the ITE hearing devices, but are however worn completely in the auditory canal. With behind-the-ear (BTE) hearing devices a housing with components such as battery and signal processing facility is worn behind the ear, and a flexible sound tube, also referred to as tube, routes the acoustic output signals of a receiver from the housing to the auditory canal, where provision is frequently made for an earpiece for reliable positioning. Receiver-in-canal behind-the-ear (RIC-BTE) hearing devices are similar to the BTE hearing devices, but the receiver is however worn in the auditory canal and instead of a sound tube, a flexible earpiece tube routes electrical signals, instead of acoustic signals, to the receiver, which is attached to the front of the earpiece tube, generally in an earpiece used for reliable positioning. Common to all housing configurations is the objective of the smallest possible housing, in order to increase wearing comfort and to reduce the visibility of the hearing device for cosmetic reasons.

Deep-fit hearing devices are similar to the CIC hearing devices and may also form part of the group of CIC hearing devices. While CIC hearing devices are nevertheless generally worn in the exterior part of the outer auditory canal, deep-fit hearing devices are moved further toward the eardrum and are worn at least partially in the interior part of the outer auditory canal. The outer auditory canal is a channel lined with skin and connects the auricle to the eardrum. In the outer, distal part of the auditory canal, which attaches directly to the auricle, this channel is formed of elastic cartilage. In the inner, proximal part, the channel is formed of temporal bone and thus consists of bone. The cartilaginous and boney part of the auditory canal are bent opposite to one another so that they cut an angle which differs from person to person. In particular, the boney part of the auditory canal is relatively sensitive to pressure and contact. Deep-fit hearing devices are at least partially worn in the sensitive boney part of the auditory canal. Upon insertion into the boney part of the auditory canal, they must also pass through the mentioned bend, which may be difficult depending on the angle of the bend. Moreover, small diameters and wound shapes of the auditory canal may further hamper the insertion.

Hearing devices include a signal processing facility, the mode of operation of which can be changed by programming or setting parameters. The operating system and/or firmware of the signal processing facility can be programmed in as software. A manual or automatic selection option for selecting one of several different programmed acoustic signal processing algorithms, also referred to as auditory programs, can be provided. Operating parameters such as amplification (volume), frequency-dependent amplification spectra, frequency compression, frequency transformation, interference signal suppression functions or targeted suppression of repeating or constant interference signals can be set, or modes of operation with the direct receipt of acoustic signals sent from telephones or consumer electronics or remote controllers can be activated by a receiving coil, also known as telecoil. Innumerable further operating parameters are conceivable which can be changed on a hearing device.

Hearing instruments can be embodied for instance as hearing devices. A hearing device is used to supply a hearing-impaired person with acoustic ambient signals, which are processed and amplified to compensate for and/or treat the respective hearing impairment. It consists in principle of one or several input transducers, a signal processing facility, an amplification facility and an output transducer. The input transducer is generally a sound receiver, e.g. a microphone, and/or an electromagnetic receiver, e.g. an induction coil. The output signal generator is generally realized as an electroacoustic transducer, e.g. miniature loudspeaker, or as an electromechanical transducer, e.g. bone conduction earpiece. It is also referred to as an earpiece or receiver. The output signal generator generates output signals, which are routed to the ear of the patient, and are to generate a hearing perception in the patient. The amplifier is generally integrated in the signal processing facility. Power is supplied to the hearing device by a battery integrated in the hearing device housing or a rechargeable battery integrated in the hearing device housing. The essential components of a hearing device are generally arranged and/or thus connected thereto on a printed circuit board as a circuit carrier.

Aside from the embodiment as a hearing device which is used to compensate for a weakened hearing ability, usually referred to as hearing impairment, hearing instruments can also be embodied as so-called tinnitus maskers. Tinnitus maskers are used to treat patients with tinnitus. They generate acoustic output signals which depend on the respective hearing impairment and, depending on the active principle, also on ambient noises, which may contribute to reducing the perception of interfering tinnitus or other ear noises. Tinnitus maskers can in principle be embodied in the same housing configurations as hearing devices. Combination devices are also known, which combine the functionality of a tinnitus masker and a hearing device in a housing.

The term hearing instrument is to be understood below both as hearing devices and also tinnitus maskers, and also other such devices.

ITE hearing instruments contain a housing, which can be inserted into the auditory canal of a hearing instrument wearer. The shape of the housing is adjusted to the auditory canal to such an extent that it has a good fit and secure hold in the auditory canal, but at the same time rests comfortably against the auditory canal wall with as little pressure as possible. For this purpose, housings adjusted individually to the hearing instrument wearer can be used.

The distal end of the housing of a ITE hearing instrument which is oriented outwards, frequently referred to as faceplate, has at least one microphone opening accessible from its surroundings, in the case of directional microphone arrangements, at least two microphone openings. Furthermore, a battery opening can be provided in the faceplate, as well as control elements such as an on/off switch or volume controller. If available, a programming connector can also be provided in the faceplate. Microphone openings are usually lined to protect against the penetration of dirt and to avoid wind noises, e.g. whistling or howling. Programming connectors are usually protected against the penetration of dirt by covers.

U.S. Pat. No. 6,473,512 B1 discloses an ITE hearing device, in which a battery compartment opening and a programming connector are provided in the faceplate. The programming connector is embodied as a standard plug, e.g. CS44. Furthermore, a microphone opening and a vent opening are also provided. The components are arranged separate from one another on the faceplate in a distributed manner.

U.S. Pat. No. 7,508,949 B2 discloses an ITE hearing device, in which a battery opening and a programming connector are provided in the faceplate. A narrow gap is provided between the battery compartment opening and the surrounding faceplate. The programming contacts are arranged behind this and are accessible through the gap.

### SUMMARY OF THE INVENTION

The object of the invention is to specify an ITE hearing instrument, which has a programming connector and at least one microphone opening in a space-saving arrangement and with a minimal number of components.

The invention achieves this object with an ITE hearing instrument having the features of the independent claims.

The basic idea behind the invention is an ITE hearing instrument having a programming connector arranged in the faceplate and at least one microphone opening arranged in the faceplate. The programming connector is covered by an openable cover, and the at least one microphone opening is covered at least partially by a lining. The cover and the lining are integrated in a shared cover and lining device, which at least partially covers both the programming connector and also at least one microphone in a manner so as to be openable. This is based on an in-the-ear instrument, an ITE hearing instrument, which can also be embodied as a CIC or deep-fit hearing instrument, known from the prior art. If the ITE hearing instrument is inserted into an auditory canal of a hearing instrument wearer, part of the housing wall of the ITE hearing instrument is oriented outwards. This part of the housing wall, which is subsequently referred to as faceplate, is the only part which is accessible from the surroundings, and preferably contains control elements and further functional structures. In particular, the faceplate is to contain at least one microphone opening, in directional microphone openings at least two microphone openings and a programming connector. Furthermore, a battery compartment opening can be provided in the face plate, as well as control elements such as an on/off switch or volume controller. The programming connector is protected against the penetration of dirt by a cover. The microphone opening and/or the microphone openings are at least partially lined for the protection against the penetration of dirt and to avoid wind noises, e.g. whistling or howling. This lining may contain openings, for instance in the form of slits or round shapes, wherein the openings may also be covered by membranes. Essential to the basic idea behind the invention is that the cover of the programming connector and at least one lining of the at least one microphone opening are integrated in a shared cover and lining device, which at least partially covers both the programming connector and also at least one microphone opening in a manner so as to openable. The cover and lining device combines the cover of the programming connector and the lining of at least one microphone opening in a component, wherein the cover and lining device is embodied in a manner so as to be openable, i.e. it can be brought into a position in which it executes the covering and lining functions, and also into a position e.g. by removing or opening and/or folding, in which the programming connector and at least one microphone opening are open, in order to connect a programming plug to the programming connector for instance.

In an advantageous development, the cover and lining device is held in its position in a covering state of at least one holding device, which is arranged on the cover and lining device and/or is integrated in the cover and lining device and/or in the faceplate. If the cover and lining device is brought into a position in which the cover and lining function can be executed, i.e. by the programming connector being covered and at least one microphone opening being lined, it is expedient if the cover and lining device can be fixed or held by the holding device in this position in order for instance to safeguard against them falling out. The holding device may be arranged here on the cover and lining device, integrated into the cover and lining device, integrated into the faceplate or embodied as a combination of the options.

In a further advantageous embodiment, the holding device has a plug-type shape, which can be inserted into the programming connector in a plug-type fashion. In the covering state, the holding function is effected between the holding device and the programming connector in particular by the form-fit shape and frictional forces. Furthermore, the holding device is also connected to the cover and lining device. In this embodiment, the holding device is realized by a plug-type component. The shape takes the shape of the programming connector, wherein in particular the clear shape of the programming connector and/or components of the programming connector, such as for instance contact pins, can be taken into account. A holding device is conceivable, which embodies almost a complete “cast” of the programming connector, a holding device which only takes a component of the programming device into account, e.g. encloses a single contact pin, or a holding device, the embodiment of which lies between these two extremes. The holding function of the holding device is expediently effected by the form-fit shape and by friction. Friction can be understood to be mean the circumferential frictional contact between the plug-type shape of the holding device and the programming connector, but also a mechanical contact between a clamp-like sleeve of the holding device and a rod-type contact pin of the programming connector.

In a further advantageous embodiment, the holding device includes two components, wherein the first component has a magnetic material and the second component has a material which is magnetically attracted by the magnetic material. At least part of one of the two components is arranged on the faceplate or integrated therein, and at least part of the other component is arranged on the cover and lining device or integrated therein. In this embodiment, the holding device is embodied as a magnetic holding or connecting device, which is based on it having materials which are attracted by a magnetic force and thus embody a holding function. The holding device necessarily includes two components, one with a magnetic material and one with a material which is magnetically attracted by the magnetic material at a small distance. At least parts of the different components are found on the faceplate and the cover and lining device.

In a further advantageous embodiment, the holding device has a detachable closing device, in particular a Velcro fastener or a hook-loop closure. In this embodiment of the holding device, the holding function is realized by a detachable closing device, such as a Velcro fastener or a hook-loop closure. Naturally a component, e.g. the hook of a hook-loop closure, is arranged here on the cover and lining device, and the other component, e.g. the loop, into which the hook can engage, is arranged on the faceplate.

A further embodiment provides for the cover and lining device to be connectable to the faceplate by a hinge and in the connected state, the cover and lining device can be opened by a rotary movement with the aid of the hinge. A hinge is usually a connecting link, which connects two parts, in most instances rotatably by an axle, to one another in a moveable manner. In this case, the hinge can connect the cover and lining device to the faceplate. A hinge may for instance be embodied as a concealed hinge or a piano hinge. An advantage with the use of a hinge lies in the cover and lining device being opened and thus access to the programming connector being enabled. Similarly the cover and lining device is however connected to the faceplate, as a result of which protection from loss is provided.

The cover and lining device particularly advantageously includes an opening aid, in particular an opening aid embodied as a holder, a hole or a blind hole. In order for instance to facilitate a user of the ITE hearing instrument with operation of the ITE hearing instrument, it is expedient to equip the cover and lining device with an opening aid. The cover and lining device could be gripped and opened with two fingers by an elevation, e.g. in the form of holder. The cover and lining device provided with a hole or a blind hole could be opened with the aid of a piece of wire or a needle.

A further advantageous embodiment is an ITE hearing instrument with two microphone openings arranged in the faceplate, both of which are covered at least partially by one or in each instance a lining, wherein the cover and the lining of the microphone opening or microphone openings are integrated in a shared cover and lining device, which at least partially covers both the programming connector and also the one microphone opening or the two microphone openings in a manner so as to be openable. This embodiment lends itself above all to the instance of two microphones frequently encountered in directional microphone arrangements. It is conceivable that the shared cover and lining device cover the programming connector and a microphone opening or the programming connector and both microphone openings in the unopened state. This also includes the possibility of one or both microphone openings being only partially covered, in order in particular to embody a sound inlet opening. Furthermore, the term cover is also understood to mean the covering with a membrane, e.g. containing a sound-permeable membrane, such as is known under the product name Gore-Tex.

A preferred embodiment of a basic idea behind the invention provides that with the ITE hearing instrument having two microphone openings arranged in the faceplate, the programming connector is arranged between the two microphone openings. This arrangement is advantageous in that the space between the two microphones, which must in most instances adhere to a given minimal distance, is used and the dimensions of the ITE hearing instrument can as a result be minimized.

The cover and lining device can preferably be inserted in a form-fit manner into a recess in the faceplate. Supplementary or in addition, the transition from the surface of the boundary area of the cover and lining device to the surface of the faceplate may essentially be seamless in the covered state. The cover and lining device are at least safeguarded against a movement parallel to the faceplate by a recess in the faceplate and the form-fit insertion of the cover and lining device. If a 2-dimensional surface forms in the covering state of the transition from the surface of the boundary area of the cover and lining device to the surface of the faceplate, i.e. the transition is seamless or edgeless, advantages result, i.e. in that less dirt can accumulate.

The cover and lining device expediently contains an essentially rectangular shape when viewed from above. Alternatively in the top view, the cover and lining device contains an essentially rectangular shape with rounded or tapering ends on two opposite sides. In practice, these shapes have proven themselves particularly if one or two microphone openings and the programming connector can be covered by the cover and lining device.

Other features which are considered as characteristic for the invention are set forth in the appended claims.

Although the invention is illustrated and described herein as embodied in an ITE hearing instrument with a programming connector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of an ITE hearing instrument according to the prior art, which is inserted into an ear;

FIG. 2 is a diagrammatic, perspective view of a faceplate with components which are visible from the outside according to the invention;

FIG. 3 is a perspective view of a detail of the faceplate with components which are visible from the outside;

FIG. 4 is a perspective view of an exemplary embodiment of an inventive cover and lining device;

FIG. 5 is a diagrammatic, cross-sectional view through an ITE hearing instrument having an exemplary embodiment of the inventive cover and lining device; and

FIG. 6 is a perspective view of an exemplary embodiment of the inventive cover and lining device with a holding device.

### SUMMARY OF THE INVENTION

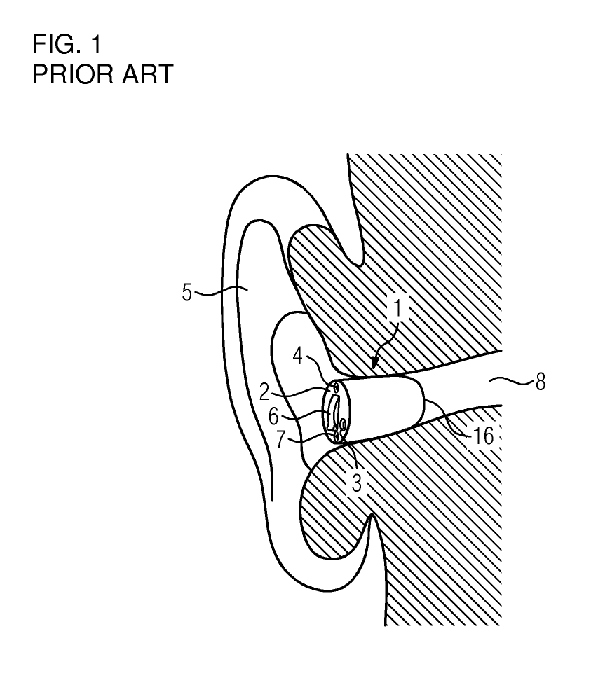

Referring now to the figures of the drawing in detail and first, particularly, to FIG. 1 thereof, there is shown a schematic representation of an ITE hearing instrument 1 according to the prior art, which is inserted into an auditory canal 8 of an ear with an auricle 5. The ITE hearing instrument 1 has a housing 16, on the end of which toward the auricle 5 a faceplate 2 can be identified. Components of the ITE hearing instrument 1, which are arranged within the housing 16, such as for instance input transducer, signal processing facility, amplification facility and output transducer, are not shown in FIG. 1. A programming connector 3, a microphone opening 4, a volume controller 6 and a ventilation opening 7 are indicated in the faceplate 2.

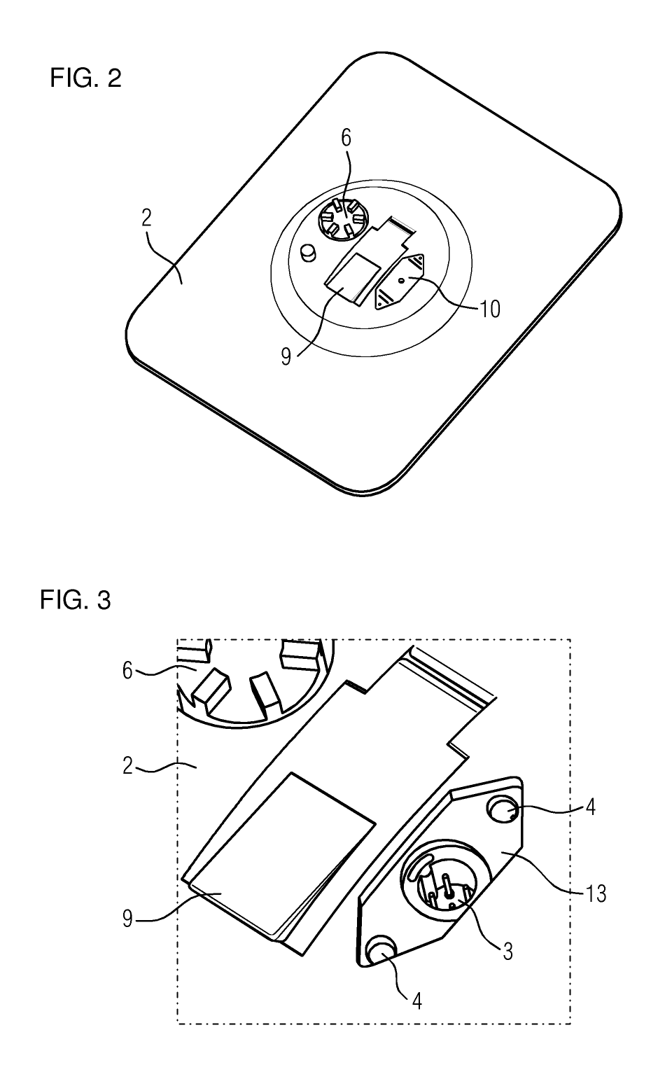

FIG. 2 shows an exemplary embodiment of the faceplate 2 with components which are visible from the outside. Aside from the already known volume controller 6 which is only embodied in an alternative form, a battery cover 9, which covers a non-illustrated battery or a non-illustrated rechargeable battery, and an embodiment of an inventive cover and a lining device 10, are shown. The cover and the lining device 10 form a component which covers both the programming connector and also at least one microphone opening in a manner so as to be openable.

FIG. 3 shows a detailed view of the exemplary embodiment from FIG. 2 having the faceplate 2, the volume controller 6 and the battery cover 9, wherein the cover and lining device is not shown, i.e. the cover and lining device is in an open or removed state and provides a free view of the two microphone openings 4 and the programming connectors 3 arranged therebetween, which is embodied as a CS44 connector. FIG. 3 shows that the microphone openings 4 and the programming connector 3 are arranged in a recess 13 of the faceplate 2.

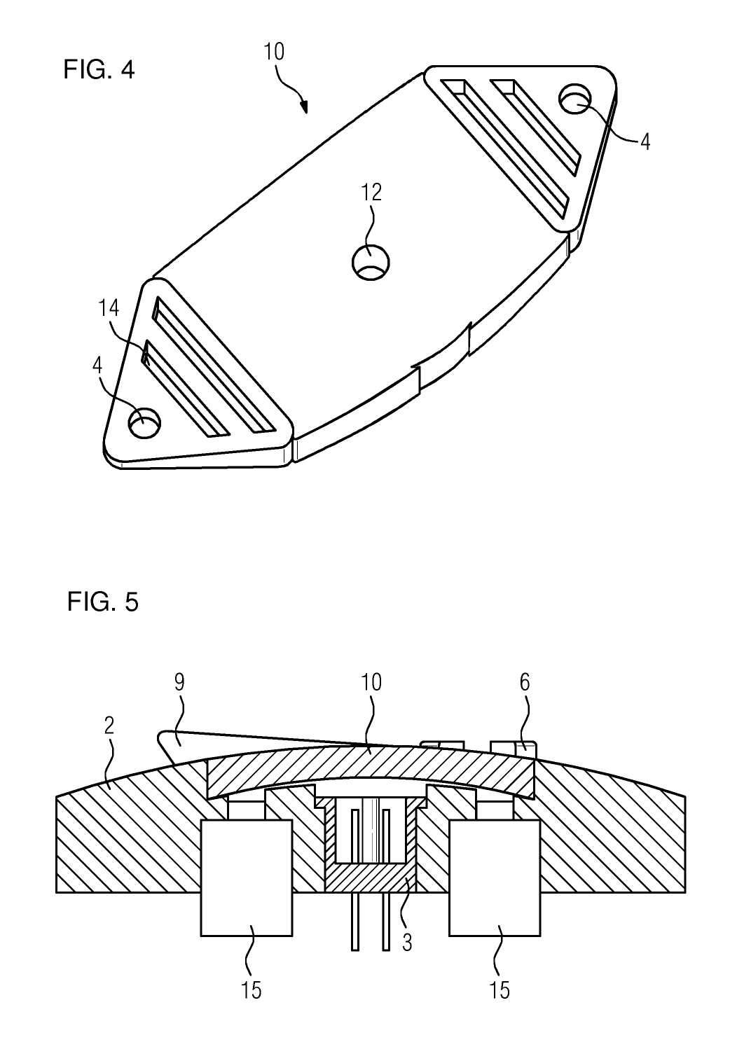

FIG. 4 shows an exemplary embodiment of the inventive cover and lining device 10 from a slightly rotated birds eye view. The cover and lining device 10 contain an essentially rectangular shape with ends tapering on two opposite sides. Microphone openings 4 and linings 14 for preventing wind noises, such as for instance whistling or howling, are shown schematically on two tapering ends. The cover and lining device 10 contains a blind hole 12 as an opening aid, with the aid of which the cover and lining device 10 can be more easily opened or removed from the faceplate. To this end, a pin-type device can be used for instance, which is inserted into the blind hole and by which a tilting movement levers the cover and lining device 10 from its position.

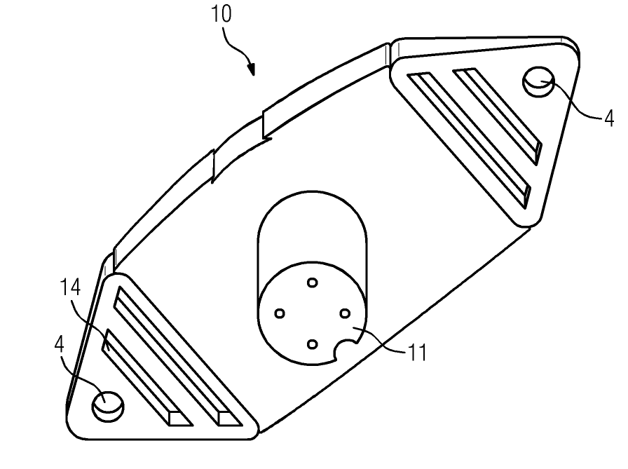

FIG. 5 shows a cutout of a cross-section through an ITE hearing instrument having an exemplary embodiment of the inventive cover and lining device 10. The faceplate 2, the volume controller 6 and the battery cover 9 are visible. The cover and lining device 10 covers the programming connector 3 and microphones 15 with its microphone openings. The cross-section shows that the surfaces of the cover and lining device 10 and of the faceplate 2 embody a curved yet symmetrical surface.

FIG. 6 finally shows an exemplary embodiment of the inventive cover and lining device 10 with a holding device 11 from a slightly rotated frogs eye view. The holding device 11 has a plug-type shape, which can be inserted into the programming connector in a form-fit manner. In the covering state, the holding function is effected by the form-fit shape and frictional forces between the holding device 11 and the programming connector. The holding device 11 is connected to the cover and lining device 10. The shape conforms with the shape of the programming connector, in this exemplary embodiment a CS44 connector, wherein the clear shape of the programming connector is reproduced and recesses for the contact pins are also taken into consideration. I.e. the holding device 11 in this exemplar embodiment is almost embodied as a complete “cast” of the programming connector. The holding function of the holding device 11 is effected in this exemplary embodiment by the form-fit shape and by friction, wherein the friction is embodied here by the circumferential frictional contact between the plug-type shape of the holding device 11 and the programming connector and the mechanical contact between the clamp-like recesses of the holding device 11 and the rod-type contact pins of the programming connector. The cover and lining device 10 contain further microphone openings 4 and linings 14. The linings 14 are shown here as slots, but may however also be embodied as impermeable notches, indentations or other structures.

1. An in-the-ear (ITE) hearing instrument, comprising:
a faceplate having at least one microphone opening formed therein;
a programming connector disposed in said faceplate; and
a cover and lining device at least partially covering both said programming connector and said at least one microphone opening in a manner so as to be openable.

2. The ITE hearing instrument according to claim 1, further comprising at least one holding device, said cover and lining device is held in position in a covering state by said at least one holding device, said at least one holding device is disposed at least one of on said cover and lining device, integrated in said cover and lining device or in said faceplate.

3. The ITE hearing instrument according to claim 2, wherein said holding device has a plug-type shape, which can be inserted into said programming connector in a form-fit fashion and that in the covering state, a holding function is effected by a form-fit shape and frictional forces between said holding device and said programming connector and that said holding device is connected to said cover and lining device.

4. The ITE hearing instrument according to claim 2, wherein said holding device contains two components, including a first component having a magnetic material and a second component having a material which is attracted magnetically by said magnetic material and that at least part of one of said two components is disposed one of on said faceplate or integrated in said faceplate, and at least part of another of said components is disposed one of on said cover and lining device or integrated in said cover and lining device.

5. The ITE hearing instrument according to claim 2, wherein said holding device has a detachable closing device.

6. The ITE hearing instrument according to claim 1, further comprising a hinge, said cover and lining device connected to said faceplate by said hinge and in a connected state of said cover and lining device can be opened by a rotary movement with an aid of said hinge.

7. The ITE hearing instrument according to claim 1, wherein said cover and lining device has an opening aid.

8. The ITE hearing instrument according to claim 1, wherein:
said cover and lining device has linings and a cover; and
said microphone opening is one of two microphone openings disposed in said faceplate, both of said microphone openings being covered at least partially by one of said linings, said cover and said linings at least partially covers both said programming connector and also at least one of said microphone openings in a manner so as to be openable.

9. The ITE hearing instrument according to claim 1, wherein said microphone opening is one of two microphone openings formed in said faceplate, and said programming connector is disposed between said two microphone openings.

10. The ITE hearing instrument according to claim 1, wherein:
said faceplate has a recess formed therein; and
said cover and lining device are inserted into said recess in a form-fit manner and that in a covered state, a transition from a surface of a boundary area of said cover and lining device to a surface of said faceplate is seamless.

11. The ITE hearing instrument according to claim 1, wherein said cover and lining device has a generally rectangular shape from a top view, and without said cover and lining device in the top view generally having a rectangular shape with ends rounded or tapering on two opposite sides.

12. The ITE hearing instrument according to claim 5, wherein said detachable closing device is selected from the group consisting of a Velcro fastener and a hook-loop closure.

13. The ITE hearing instrument according to claim 7, wherein said opening aid is selected from the group consisting of a holder, a hole, and a blind hole.
